(19) United States
(12) Patent Application Publication
(10) Pub. No.: US 2011/0083504 A1
(43) Pub. Date: Apr. 14, 2011

(54) Device for measuring the fill level in a liquid container

(76) Inventor: Hiie-Mai Unger, Stuttgart (DE)

(21) Appl. No.: 12/923,918

(22) Filed: Oct. 14, 2010

(30) Foreign Application Priority Data
Oct. 14, 2009 (DE) 10 2009 045 667.8

(51) Int. Cl. G01F 23/26; G01F 23/296; G01F 23/30

(52) U.S. Cl. 73/304 C; 73/290 V; 73/305

(57) ABSTRACT

A device for measuring the fill level in a liquid container has a fill level sensor secured in the liquid container. According to the invention the fill level sensor is supported in pendulum-like fashion on the liquid container about at least one rotary axis.

### CROSS-REFERENCE TO RELATED APPLICATION

This application is based on German Patent Application 10 2009 045 667.8 filed on Oct. 14, 2009.

### BACKGROUND OF THE INVENTION

1. Field of the Invention

The invention is based on a device for measuring the fill level in a liquid container.

2. Description of the Prior Art

Such devices are widely used in the industry and serve for instance to monitor the fill level in the fuel tank or coolant tank of a motor vehicle. For instance, if the level in the tank is too low or has dropped below a lower limit value, then the fill level sensor transmits a corresponding electrical signal to an evaluation and control unit, which outputs a corresponding warning to the user. As a result, an unwanted functional problem of the motor vehicle, or imminent engine damage, is averted.

For detecting the fill level in a liquid container, measuring devices having the following fill level sensors are for instance known: floats with or without a lever transducer; ultrasonic sensors; and capacitive sensors.

In all these known measuring devices, the fill level sensor is plunged into the liquid only with a non-inclined, horizontally oriented liquid container at right angles to the surface of the liquid, that is, vertically. Conversely, if the liquid container is inclined, then the fill level sensor is also tilted relative to the vertical by the applicable angle of inclination, which means changed measurement connections and can therefore lead to errors of measurement. Thus all of the known measuring devices employ a measurement signal whose measurement conditions vary with the inclination of the liquid container. To ensure what is nevertheless as exact as possible a measurement of the fill level, an additional sensor system, such as an inclination sensor, and suitable software are therefore necessary, to eliminate such inclination-dependent measurement errors in the measurement signal. Depending on the slanted position of the liquid container, and on the measurement principle, in the prior art it may no longer be possible to evaluate the measurement signals at all.

### OBJECT AND SUMMARY OF THE INVENTION

It is by comparison the object of the invention to refine a measuring device of this generic type such that regardless of the inclination of the liquid container, the same measurement conditions always prevail at the fill level sensor.

By means of an inventive pendulum bearing, the fill level sensor is always, because of its weight, oriented in the direction of gravity and perpendicular to the surface of the liquid, so that regardless of the inclination of the container at the time, the same measurement conditions always exist at the fill level sensor. Thus the application effort and expense that have been required until now to ensure an exact measurement, such as the use of an additional sensor system on the order of an inclination sensor or complicated software adaptation of the measurement signal, are eliminated. For instance, the fill level in the fuel tank of a motor vehicle can be reliably measured during the operation and travel situations typically encountered in the motor vehicle.

Preferably, the fill level sensor on the liquid container is supported in pendulum-like fashion about two rotary axes, and in particular via a cardan joint or a combined rotary/pivot bearing, or on all sides, in particular via a ball joint or a rope suspension. By this provision, for every inclination of the liquid container, a vertical or in other words plumb orientation of the fill level sensor to the liquid surface is always ensured.

The liquid sensor is advantageously embodied as an ultrasonic sensor or optical sensor for contactless fill level measurement, and as a capacitive or mechanical sensor with a float for contact measurement.

For fill level measurements with high precision, or in liquid containers with a complex internal geometry, an additional inclination sensor for correcting the fill level measured with the fill level sensor is advantageously provided on the liquid container. This inclination sensor can also be integrated with the pendulum bearing of the fill level sensor.

In an especially preferred embodiment of the invention, an evaluation unit is provided as well, which as a function of the inclination of the liquid container and/or of the container geometry recalculates the fill level, measured with the fill level sensor, to the fill level for a non-inclined liquid container.

### BRIEF DESCRIPTION OF THE DRAWINGS

The invention will be better understood and further objects and advantages thereof will become more apparent from the ensuing detailed description-of preferred embodiments taken in conjunction with the drawings, in which:

FIGS. 1a and 1b show a longitudinal section through a first exemplary embodiment of the measuring device of the invention, with a cardanically suspended, capacitive fill level sensor with an untilted liquid container (FIG. 1a) and a tilted liquid container (FIG. 1b);

FIG. 2 shows a measuring device of the prior art with a rigidly disposed capacitive fill level sensor and a tilted liquid container;

FIGS. 3a and 3b show a longitudinal section through a second exemplary embodiment of the measuring device of the invention, with a cardanically suspended ultrasonic fill level sensor in an untilted liquid container (FIG. 3a) and with a tilted liquid container (FIG. 3b);

FIG. 4 shows a measuring device of the prior art with a rigidly disposed ultrasonic fill level sensor and a tilted liquid container;

FIG. 5 is a longitudinal section through a third exemplary embodiment of the measuring device of the invention, with a fill level sensor suspended from a ball joint in an untilted liquid container; and

FIG. 6 is a longitudinal section through a fourth exemplary embodiment of the measuring device of the invention, with a fill level sensor suspended from a rope in an untilted liquid container.

### DESCRIPTION OF THE PREFERRED EMBODIMENTS

In the drawings, components corresponding to one another in the various exemplary embodiments are expediently identified by the same reference numerals.

All the drawings show a pairing of a measuring device and a bearing, which should be understood as an example. The various measuring devices and bearings shown can be arbitrarily combined with one another.

In the drawings, a device, identified overall by 10, for measuring the fill level 12 of a liquid 16 disposed in a liquid container 14 is shown. The liquid container 14 has a top portion 18, on which a fill level sensor 20 is disposed approximately in the center.

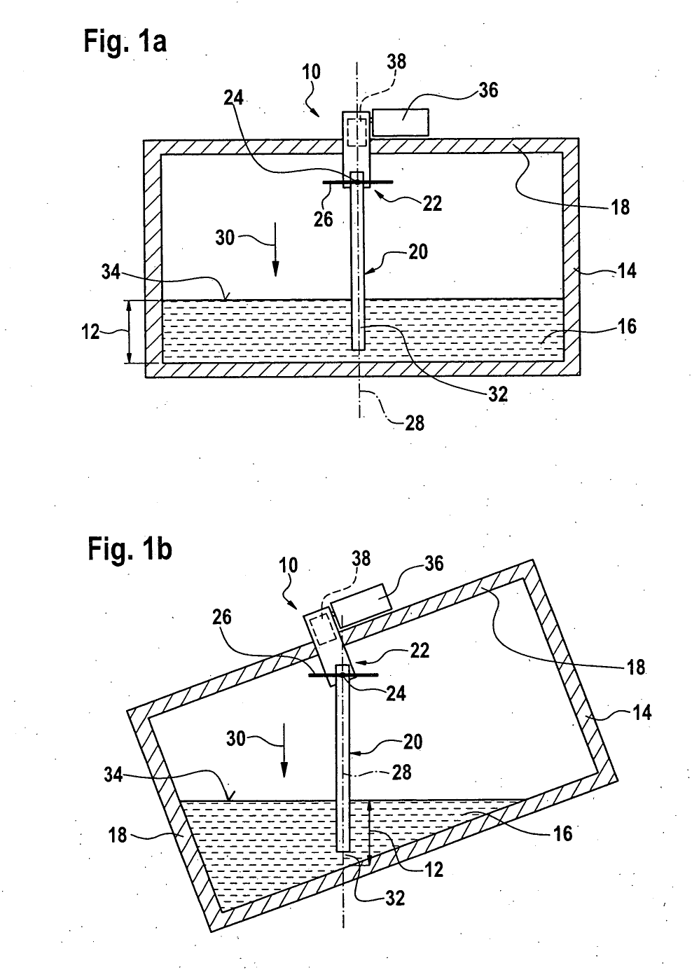

In the exemplary embodiment shown in FIGS. 1a and 1b, the fill level sensor 20 is embodied as a capacitive sensor, which on its upper end is supported or suspended in pendulum-like fashion by means of a cardan joint or universal joint 22 about two horizontal rotary axes 24, 26 extending at right angles to one another. The liquid container 14 is shown in FIG. 1a in its horizontal neutral position and in FIG. 1b in what by comparison is an inclined position. As a result of the cardan suspension, the fill level sensor 20 with its longitudinal axis 28 is always, because of its weight, oriented in the direction of gravity 30 and therefore always plunges with a capacitive measuring portion 32 of the fill level sensor, provided on the lower end thereof, into the liquid 16 perpendicular to the surface 34 of the liquid. Thus regardless of the inclination of the liquid container 14, the fill level sensor 20 always plunges in the same way, namely at a right angle, into the liquid 16, so that regardless of the inclination of the liquid container 14 at any time, the same measurement conditions always prevail. The fill level sensor 20 generates a measurement signal, which is dependent on the fill level 12 and is evaluated by an evaluation unit 36 connected to the fill level sensor 20.

In liquid containers with a complex internal geometry, an inclination sensor 38 for correcting the fill level measured with the fill level sensor 20 can additionally be provided on the liquid container 14. As indicated by dashed lines, the inclination sensor 38 can be integrated directly with the cardan joint 22 and can advantageously form a structural unit with it. The evaluation unit 36 recalculates the fill level 12 measured by the fill level sensor 20 then to the fill level of the non-inclined liquid container 14, taking into account both the inclination signal of the inclination sensor 38 and the container geometry.

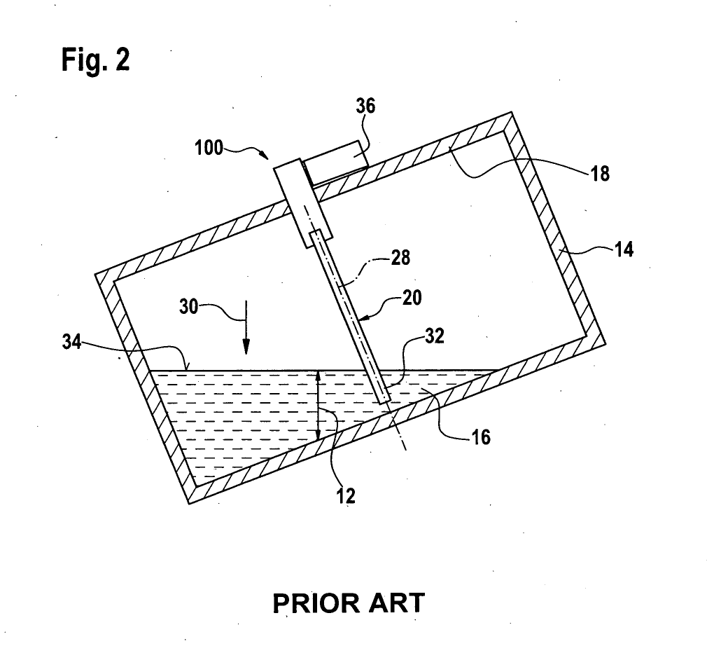

By comparison, FIG. 2 shows a measuring device 100 of the prior art, with a capacitive fill level sensor 20 disposed rigidly on the top portion 18 of the liquid container 14. Only in the horizontal neutral position of the liquid container 14 does the fill level sensor 20 plunge with its longitudinal axis 28 or its measuring portion 32 into the liquid 16 at a right angle to the surface 34 of the liquid, or in other words vertically. Conversely, if as in FIG. 2 the liquid container 14 is tilted relative to the horizontal, then the fill level sensor 20 plunges into the liquid 16 tilted by the applicable angle of inclination from the vertical indicated by gravity 30, which means changed measurement connections and therefore can lead to measurement errors.

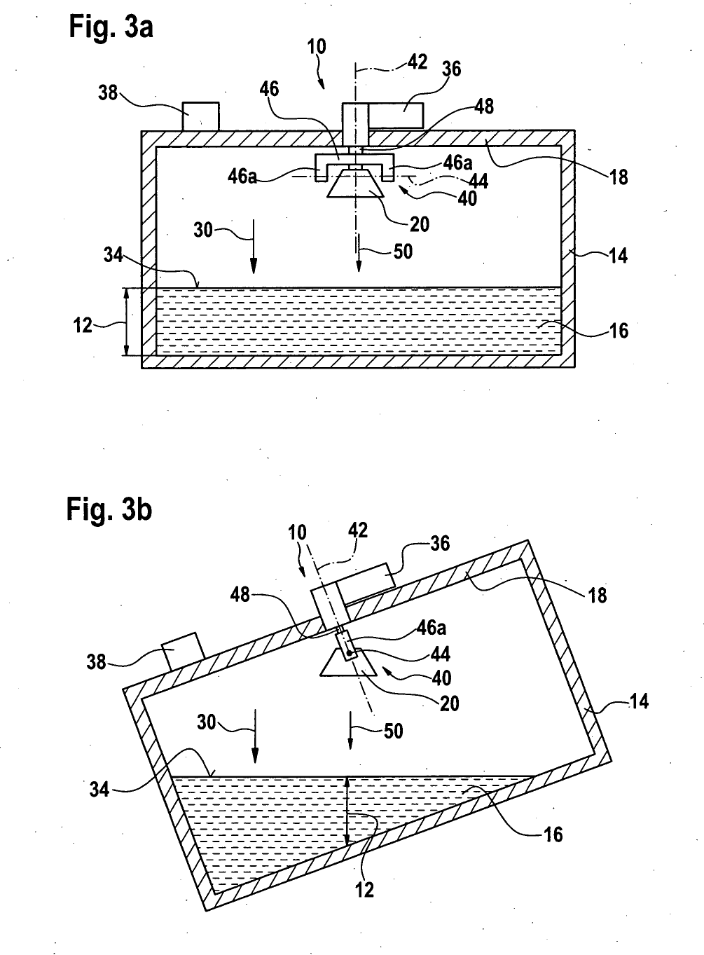

In the measuring device 10 shown in FIGS. 3a and 3b, the measurement of the fill level 12 is effected by means of a fill level sensor 20 embodied as an ultrasonic sensor, which is supported or suspended in pendulum-like fashion via a rotary/pivot bearing 40 about two rotary axes 42, 44. The rotary/pivot bearing 40 is formed by a mount 46, which is supported freely rotatably about the first rotary axis 42 which is oriented vertically in FIG. 3a and on which in turn the fill level sensor 20 embodied as an ultrasonic sensor is supported pivotably about the second rotary axis 44, which in FIG. 3a is oriented horizontally. In the exemplary embodiment shown, the mount 46 has an axial element 48, which is supported on the top portion 18 of the liquid container 14 freely rotatably about the first rotary axis 40, and the fill level sensor 20 embodied as an ultrasonic sensor is supported pivotably about the second rotary axis 44 between two legs 46a of what here is a forklike mount 46. The liquid container 14 is shown in FIG. 3a in its horizontal neutral position and in FIG. 3b in what by comparison is an inclined position. As a result of the rotary/pivot bearing 40, the fill level sensor 20, with its ultrasonic measuring device 50, is because of its weight always oriented in the direction of gravity 30 and at right angles to the surface 34 of the liquid. Unlike in FIG. 1, the inclination sensor 38 here is disposed as a separate sensor on the liquid container 14. Alternatively, the fill level sensor 20 can be embodied as an optical sensor.

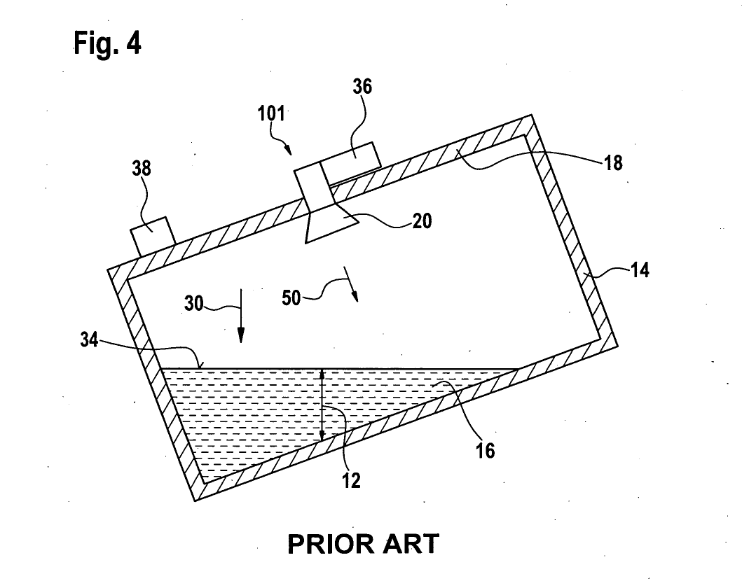

By comparison, FIG. 4 shows a measuring device 101 of the prior art, with an ultrasonic sensor 20 disposed rigidly on the top portion 18 of the liquid container 14. Only in the horizontal neutral position of the liquid container 14 is the ultrasonic sensor 20, with its ultrasonic measuring device 50, oriented in the direction of gravity 30 and at a right angle to the surface 34 of the liquid. If conversely the liquid container 14, as in FIG. 4, is inclined from the horizontal, then the ultrasonic measuring device 50 is tilted from the vertical 30 by the applicable angle of inclination, which means changed measurement connections and can therefore lead to measurement errors.

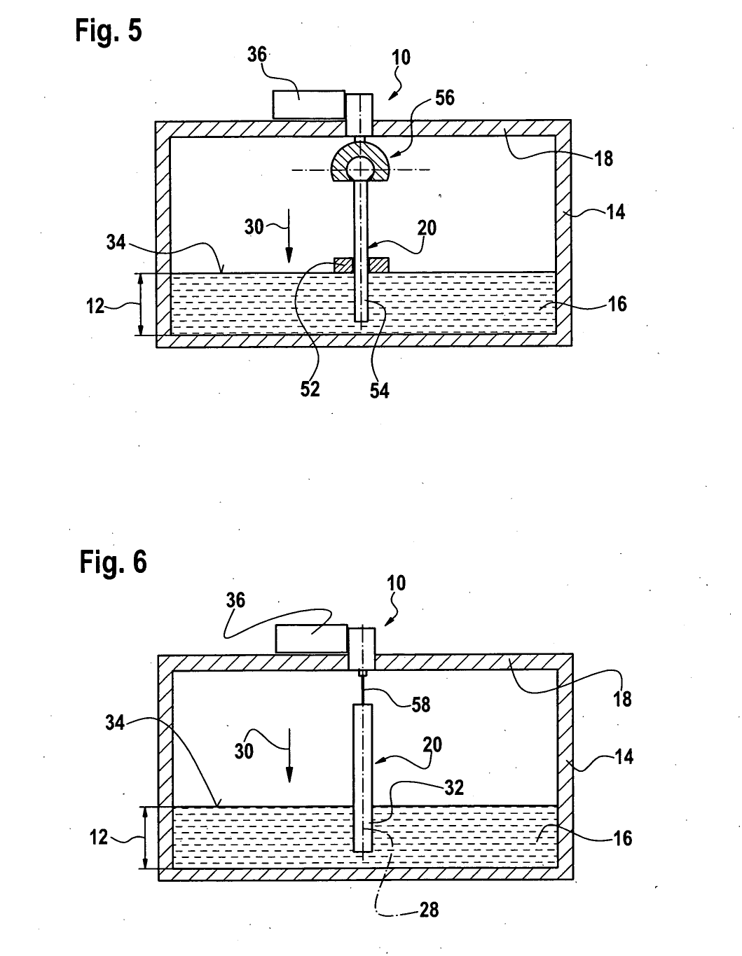

In the measuring device 10 shown in FIG. 5, the fill level sensor 20 is embodied as a mechanical sensor with a float 52, which is guided displaceably on a guide rod 54. The guide rod 54 is secured, swinging freely on all sides, via a ball joint (ball-and-socket receptacle) 56 on the top portion 18 of the liquid container 14. As a result, because of its weight, the fill level sensor 20 with its guide rod 54 is always oriented in the direction of gravity 30 and at a right angle to the surface 34 of the liquid, and the float 52 always floats with its full surface on the surface 34 of the liquid.

In the measuring device 10 shown in FIG. 6, the fill level sensor 20 is embodied, for instance as in FIG. 1, as a capacitive sensor and is suspended via a cable or rope suspension 58 on the top portion 18 of the liquid container 14. As a result, the fill level sensor 20 with its longitudinal axis 28 or its measuring portion 32 is always oriented in the direction of gravity 30 and at a right angle to the surface 34 of the liquid.

The foregoing relates to preferred exemplary embodiments of the invention, it being understood that other variants and embodiments thereof are possible within the spirit and scope of the invention, the latter being defined by the appended claims.

1. A device for measuring the fill level in a liquid container, comprising a fill level sensor secured in the liquid container and being supported, in particular in pendulum-like fashion, on the liquid container about at least one rotary axis.

2. The measuring device as defined by claim 1, wherein the fill level sensor on the liquid container is supported in pendulum-like fashion about two rotary axes, in particular via a cardan joint or a combined rotary/pivot bearing.

3. The measuring device as defined by claim 1, wherein the fill level sensor is supported in pendulum-like fashion on the liquid container on all sides, in particular via a ball joint or a cable suspension.

4. The measuring device as defined by claim 1, wherein the fill level sensor is intended for contactless fill level measurement and is embodied as an ultrasonic sensor or an optical sensor.

5. The measuring device as defined by claim 2, wherein the fill level sensor is intended for contactless fill level measurement and is embodied as an ultrasonic sensor or an optical sensor.

6. The measuring device as defined by claim 2, wherein the fill level sensor is intended for contactless fill level measurement and is embodied as an ultrasonic sensor or an optical sensor.

7. The measuring device as defined by claim 1, wherein the fill level sensor is intended for contact measurement and is embodied as a capacitive sensor.

8. The measuring device as defined by claim 2, wherein the fill level sensor is intended for contact measurement and is embodied as a capacitive sensor.

9. The measuring device as defined by claim 3, wherein the fill level sensor is intended for contact measurement and is embodied as a capacitive sensor.

10. The measuring device as defined by claim 1, wherein the fill level sensor is intended for contact measurement and is embodied as a mechanical sensor with a float.

11. The measuring device as defined by claim 2, wherein the fill level sensor is intended for contact measurement and is embodied as a mechanical sensor with a float.

12. The measuring device as defined by claim 3, wherein the fill level sensor is intended for contact measurement and is embodied as a mechanical sensor with a float.

13. The measuring device as defined by claim 1, wherein an inclination sensor for correcting the fill level measured with the fill level sensor is provided on the liquid container or on a component connected to it.

14. The measuring device as defined by claim 2, wherein an inclination sensor for correcting the fill level measured with the fill level sensor is provided on the liquid container or on a component connected to it.

15. The measuring device as defined by claim 3, wherein an inclination sensor for correcting the fill level measured with the fill level sensor is provided on the liquid container or on a component connected to it.

16. The measuring device as defined by claim 4, wherein the inclination sensor is integrated with a bearing of the fill level sensor.

17. The measuring device as defined by claim 7, wherein the inclination sensor is integrated with a bearing of the fill level sensor.

18. The measuring device as defined by claim 10, wherein the inclination sensor is integrated with a bearing of the fill level sensor.

19. The measuring device as defined by claim 1, further comprising an evaluation unit, which as a function of an inclination of the liquid container and/or of the container geometry recalculates the fill level, measured by the fill level sensor, to the fill level for a non-inclined liquid container.

20. The measuring device as defined by claim 2, further comprising an evaluation unit, which as a function of an inclination of the liquid container and/or of the container geometry recalculates the fill level, measured by the fill level sensor, to the fill level for a non-inclined liquid container.
